(19) United States
(12) Patent Application Publication
(10) Pub. No.: US 2021/0331300 A1
(43) Pub. Date: Oct. 28, 2021

(54) QUICK CHANGE INDEXABLE RATCHET HEAD

(71) Applicant: Snap-on Incorporated, Kenosha, WI (US)

(72) Inventor: Ben T. Schulz, Racine, WI (US)

(73) Assignee: Snap-on Incorporated, Kenosha, WI (US)

(21) Appl. No.: 16/860,410

(22) Filed: Apr. 28, 2020

(51) Int. Cl. B25B 23/00; B25B 21/00

(52) U.S. Cl. CPC B25B 23/0007; B25B 21/002; B25B 21/004

(57) ABSTRACT

A tool having a housing assembly, a driver assembly coupled to housing assembly and adapted to drive a work piece. The driver assembly includes a head portion indexably and releasably coupled to a base portion. The head portion can be one of a number of interchangeable head portions. One of the head portion and the base portion includes tabs extending outwardly in a radial direction. The other of the head portion and the base portion includes corresponding grooves adapted to respectively receive the tabs to indexably couple the head portion to the base portion.

### TECHNICAL FIELD OF THE INVENTION

The present invention relates generally to hand tools for applying torque to a work piece.

More particularly, the present invention relates to a quick-change head of a hand tool.

### BACKGROUND OF THE INVENTION

Hand tools, such as motorized ratchet wrenches and drivers, are commonly used in automotive, industrial, and household applications to tighten and untighten work pieces, such as threaded fasteners, and to apply a torque and/or angular displacement to a work piece, for example. Hand tools, such as power ratchets and drivers, generally include a motor contained in a housing, along with other components such as switches, light emitting diodes (LEDs), and a power source (e.g., battery), for example. Motorized hand tools also generally include a head driven by the motor to transfer torque to an engaged work piece. However, typically the head is coupled to the tool and is only adapted for a single size of sockets or bits, such as, for example, a ¼″ square drive ratchet lug. Accordingly, a different tool must be purchased if, for example, a ⅜″ square lug is required for a task. This requires multiple tools to be purchased, maintained, and transported to a worksite.

In addition, the head is typically oriented in a single position relative to the housing. This requires that the base must be held in a certain position so that the head can drive the work piece. However, if the work piece is located in a tight or difficult to reach environment, it may be difficult or impossible to hold the motorized hand tool in position to drive the work piece.

### SUMMARY OF THE INVENTION

The present invention relates broadly to an interchangeable, indexable head of a tool that includes a partial turn-style locking mechanism to releasably couple the head to the base. The head and the base include cooperative tabs formed on one of the head and base portions that correspond to matching cooperative receiving grooves formed on the other of the head and base portions without the tabs. Ball detents are used to provide a bias force that retain the head portion to the base portion. The one of the head and base portions that includes the receiving grooves also includes detent pockets that the ball cooperatively engages. The tabs and receiving grooves allow the head portion to be oriented relative to the base portion based on the need of the user. This allows the ratchet to be indexed to a position that allows the tool to reach tight or difficult to reach environments. This also allows a single base tool to be used with a number of interchangeable heads for a number of tasks, instead of multiple tools. For example, an interchangeable head having a ¼″ square drive ratchet lug can be substituted with another interchangeable head having a ⅜″ square drive ratchet lug that is releasably coupled to the base, instead of requiring the use of a different tool.

In particular, the present invention broadly comprises a tool. The tool includes a housing assembly and a driver assembly coupled to the housing assembly and adapted to drive a work piece. The driver assembly includes a head portion indexably or rotatably coupled to a base portion. One of the head portion and the base portion includes tabs and the other of the head portion and the base portion includes corresponding grooves adapted to cooperatively receive the tabs to indexably/rotatably and releasably couple the head portion to the base portion.

In another embodiment, the present invention can further broadly comprise a driver assembly of a motorized ratchet tool adapted to drive a work piece that includes a base portion and a head portion rotatably coupled to the base portion. One of the head portion and the base portion includes tabs and the other of the head portion and the base portion includes corresponding grooves adapted to cooperatively receive the tabs. One of the head portion and the base portion includes detent balls biased outwardly by biasing members and the other of the head portion and the base portion includes corresponding detents adapted to respectively receive the detent balls.

In another embodiment, the present invention further broadly comprises a method of rotatably coupling a driver assembly of a tool. The method including aligning tabs disposed on one of a head portion of the driver assembly and a base portion of the driver assembly with correspondingly grooves formed in the other of the head portion and the base portion, rotating the head portion relative to the base portion, and aligning detent balls disposed on one of the head portion and the base portion with corresponding detents disposed on the other of the head portion and the base portion.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1A is a side plan view of an exemplar tool, such as a motorized ratchet tool, in accordance with an embodiment of the present invention.

FIG. 1B is a top plan view of an exemplar tool, such as a motorized ratchet tool, in accordance with an embodiment of the present invention.

FIG. 2 is a perspective exploded view of the tool of FIGS. 1A and 1B, in accordance with an embodiment of the present invention.

FIG. 3 is a perspective side view of a clamshell housing portion, in accordance with an embodiment of the present invention.

FIG. 4 is perspective side view of an exemplar driver assembly, in accordance with an embodiment of the present invention.

FIG. 5 is an exploded perspective side view of the driver assembly of FIG. 4, in accordance with an embodiment of the present invention.

FIG. 6 is perspective side view an exemplar base portion of the driver assembly of FIG. 4, in accordance with an embodiment of the present invention.

FIG. 7 is perspective side view of an exemplar head portion of the driver assembly of FIG. 4, in accordance with an embodiment of the present invention.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention broadly comprises a motorized hand tool, such as a motorized ratchet tool, with a housing and an interchangeable or releasably coupled head that allows the user to index the head in different orientations in relation to the housing. A single tool can thus be used with any number of interchangeable heads that perform a number of different tasks. The interchangeable head includes a partial turn-style locking mechanism to indexably/rotatably and releasably couple a head section to a base section. The interchangeable head enhances the ability of the tool to reach hard to access work pieces, compared to current solutions. In addition, the ability to remove and change the head of the tool allows a single tool to be able to perform a number of tasks without requiring additional tools.

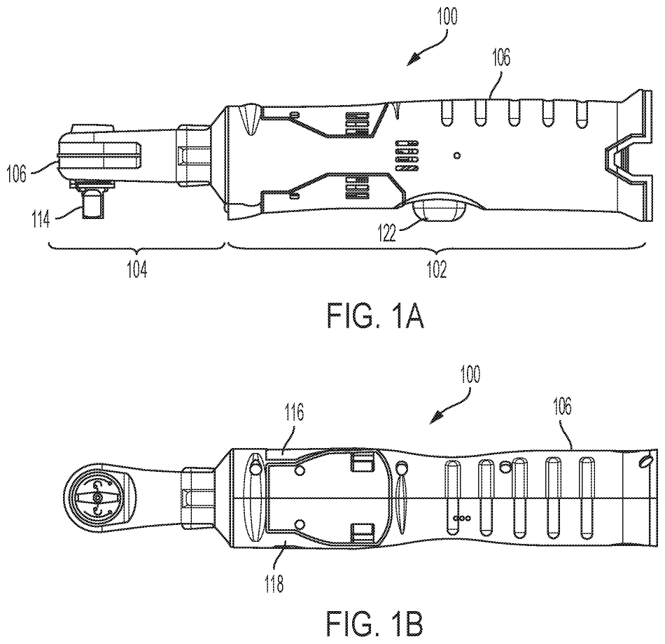

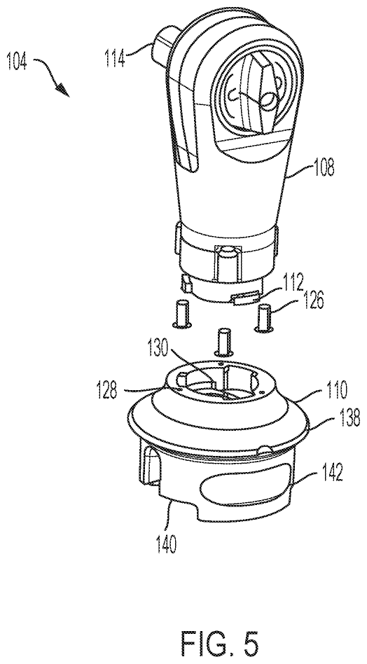

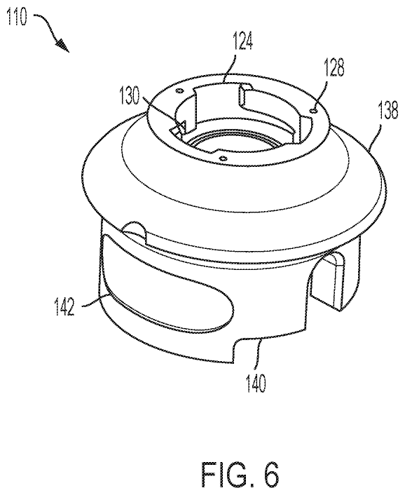

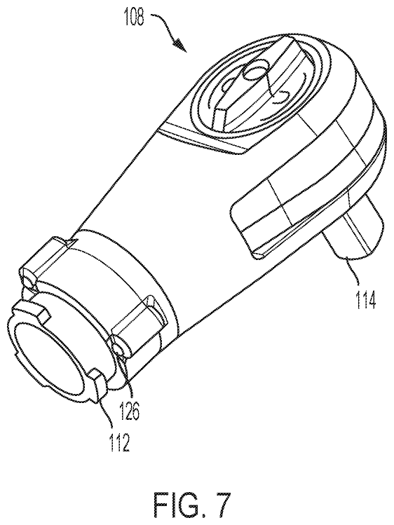

Referring to FIGS. 1-7, a tool 100, such as a motorized ratchet tool, includes a housing assembly 102 adapted to be held by a user. A driver assembly 104 is coupled to the housing assembly. The driver assembly 104 is adapted to apply torque to a work piece and is described in more detail below. The driver assembly 104 may be a ratchet head of a ratchet tool. In an embodiment, the housing assembly 102 encloses one or more of a motor 120, a switch assembly, one or more status indicators, such as light emitting diodes (LED), for example, and/or a power source, such as a battery. In an embodiment, the housing assembly 102 may be assembled from two or more clamshell housing portions 116, 118 coupled together. The housing assembly 102 may also include a handle portion 106 that a user may grip or hold to operate the tool 100.

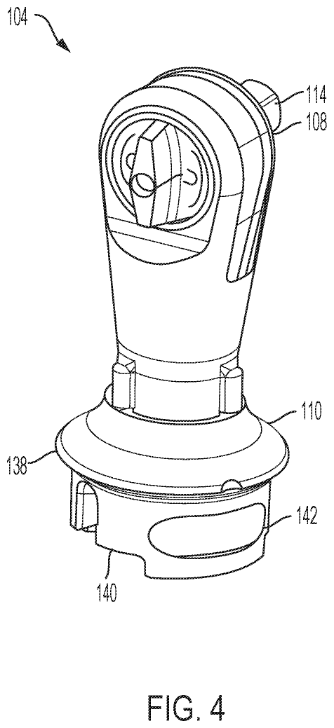

The driver assembly 104 is described with reference to FIGS. 4-7. The driver assembly 104 may be coupled to the motor 120 by fasteners, such as rivets or screws, respectively through fastener holes, for example. In an embodiment, a compressible member such a steel wave washer or an O-ring (not shown) made from a elastomeric material, such as rubber or other elastomer, for example, may be disposed between the motor 120 and the driver assembly 104 to absorb dimensional tolerances and to provide pressure that facilitates a tight fit and alignment of drive gears, for example.

In an embodiment, the driver assembly 104 includes a head portion 108 and a base portion 110. A partial turn style locking mechanism may be used to indexably/rotatably and releasably couple the head portion 108 to the base portion 110. The head portion 108, being releasably coupled to the base portion 110, can be one interchangeable head of a number of interchangeable head portions that are capable of performing a number of different tasks. Accordingly, the base portion 110 can be used with any number of interchangeable head portions, thereby allowing a single base tool to be used for performing a number of tasks, instead of multiple tools. For example, one of the number of interchangeable heads can have a ¼″ square drive ratchet lug. If a task requires a ⅜″ square drive, another interchangeable head having a ⅜″ square drive ratchet lug can be releasably coupled to the base portion 110 instead of requiring the use of a different tool. Also, interchangeable heads with tool bits could be used as well (for example, flathead or Philips screwdriver bit).

The partial turn style locking mechanism includes tabs 112 extending outwardly from the head portion 108 in a radial direction. Corresponding grooves 124 are formed in the base portion 110 and adapted to receive the tabs 112. The grooves 124 are formed in an axial direction and a circumferentially along an interior surface of the base portion 110, as shown. In this example, three tabs 112 and three corresponding grooves 124 are shown, which allows the orientation of the head portion 108 to be indexed at three positions that are 120° apart in relation to the base portion 110. However, any number of tabs and grooves may be used. In another embodiment, not shown, the grooves 124 are formed in the head portion 108, and the base portion 110 includes the tabs 112.

The head portion 108 includes a number of detent balls 126. The detent balls 126 are biased outwardly by a biasing member, such as, for example, a spring. The detent balls 126 may be part of spring ball plungers that are press fit into the head portion 108, as shown in FIGS. 4-7. The base portion 110 has a corresponding number of detents 128 adapted to respectively receive the detent balls 126. In another embodiment, not shown, the base portion 110 includes the detent balls 126, and the head portion 108 includes the corresponding detents 128. Although three detent balls 126 and detents 128 are shown, any number may be used.

In this embodiment, the tabs 112, grooves 124, detent balls 126, and detents 128 make up the partial turn style locking mechanism to indexably/rotatably and releasably couple the head portion 108 and the base portion 110 together. To couple the head portion 108 and the base portion 110 together, the tabs 112 are substantially aligned with the respective corresponding grooves 124 at a desired position and inserted in an axial direction into the base portion 110. The head portion 108 is then rotated relative to the base portion 110 until the tabs 112 reach ends 130 of the grooves 124, and/or the detent balls 126 are engaged with the corresponding detents 128, thereby releasably coupling the head portion 108 to the base portion 110. To uncouple the head portion 108 and the base portion 110, the method described above is reversed. For example, a rotational force is applied to the head portion 108 that is sufficient to disengage the detent balls 126 from the corresponding detents 128. The head portion 108 is rotated relative to the base portion 110 until the tabs 112 are able to be removed from the grooves 124 in an axial direction.

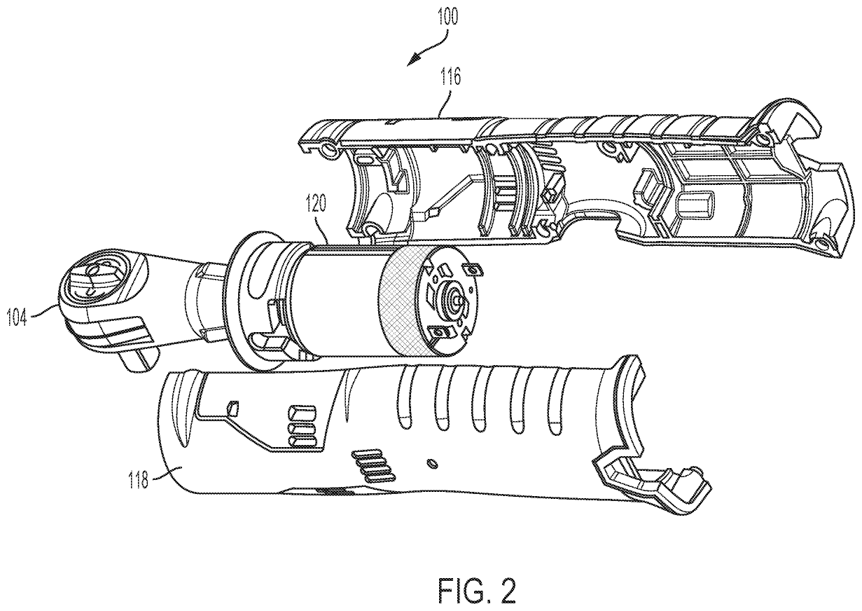

The driver assembly 104 includes a lug 114 adapted to engage a tool (e.g., socket or bit) to drive a work piece, for example, in a well-known manner. The lug 114 is operatively coupled to and driven by the motor 120 via a ratcheting mechanism (not shown) of the driver assembly 104. FIG. 2 shows the driver assembly 104 of the tool 100 coupled to the motor 120 according to an aspect of the present invention. The first clamshell housing portion 116 and second clamshell housing portion 118 are configured to couple together and subsequently house the driver assembly 104 using fasteners such as screws or rivets, for example, thereby enclosing one or more of the motor 120, the switch assembly, the status indicators, and/or the power source. When assembled, as shown in FIGS. 1A and 1B, for example, the inward protrusions on the clamshell housing portions 116, 118, as described below, prevent the driver assembly 104 from rotating or moving axially relative to the clamshell housing portions 116, 118.

The motor 120 can be, for example, an electric motor electrically coupled to the power source via the switch assembly. The power source can be external (e.g., an electrical wall outlet) or internal (e.g., a battery). The switch assembly can be adapted to cause the motor 120 to be turned ON and OFF, and/or change the rotational direction of the output of the motor 120 or speed of the motor 120. The switch assembly may include a switch 122, such as an actuation mechanism that employs a push button actuator or other type of actuator. Alternatively, the switch 122 can be a toggle actuator, a touch sensitive actuator, a slide actuator, or other suitable actuator or device.

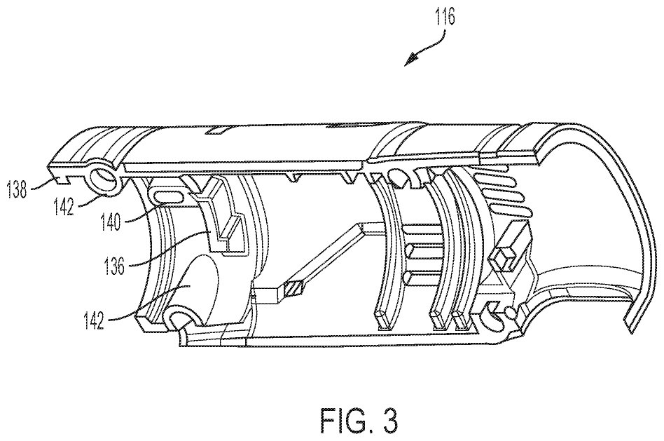

Referring to FIG. 3, according to another embodiment of the present invention, one or more protrusions extend inwardly from a first clamshell housing portion 116. The protrusions may respectively engage cooperatively shaped voids in the base portion 110 of the driver assembly 104 The protrusions may include a radial flange 138, a T-shaped protrusion 140, and/or one or more screw bosses 142. Referring to FIGS. 4-7, the base portion 110 may include a radial flange slot 138, a T-shaped aperture 140 and/or one or more concave channels 142 arranged to receive the radial flange 138, the T-shaped protrusion 140 and/or the one or more screw bosses 142, respectively.

The second clamshell housing portion 118 may also include radial flange 138, a T-shaped protrusion 140 and/or one or more screw bosses 142 engaged with the radial flange slot 138. The one or more protrusion described above are intended to reduce parts count and eliminate the manufacturing steps that would otherwise be needed to install clamp nuts or screws dedicated to fastening the driver assembly to the clamshell housing. The disclosed tool 100 may be constructed with or without externally projecting clamp nuts or screws that could loosen and/or interfere with comfortable use of the tool.

As discussed above, the aspects of the present invention are described in terms of a motorized ratchet tool, as shown. However, it should be understood that aspects of the present invention could be implanted in other hand tools or implements. For example, and without limitation, the hand tool can be ratchet wrench, open wrench, screw driver, nut driver, or any other tool capable of applying torque to a work piece. The present invention allows for a single tool to be indexably coupled with a variety of interchangeable heads to save space and cost compared to the current art solutions.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a housing assembly;
a driver assembly coupled to the housing assembly and adapted to drive a work piece, the driver assembly includes a base portion and a head portion indexably and releasably coupled to the base portion,
wherein one of the head and base portions includes tabs and the other of the head and base portions includes corresponding grooves adapted to respectively receive the tabs to indexably and releasably couple the head portion to the base portion.

2. The tool of claim 1, wherein the housing assembly encloses one or more of a motor, a switch assembly, and a status indicator.

3. The tool of claim 1, wherein the tool is a motorized ratchet tool.

4. The tool of claim 1, wherein the tabs extend outwardly from the head portion in a radial direction.

5. The tool of claim 1, wherein the grooves are formed along an interior surface of the base portion in an axial direction and a circumferential direction.

6. The tool of claim 1, wherein one of the head and base portions includes detent balls biased outwardly by respective biasing members and the other of the head and base portions includes corresponding detents adapted to respectively receive the detent balls.

7. The tool of claim 1, wherein the housing assembly includes a clamshell housing having a first clamshell housing portion coupled to a second clamshell housing portion around the base portion.

8. The tool of claim 7, further comprising: a motor assembly coupled to the driver assembly and enclosed within the clamshell housing.

9. A driver assembly of a motorized ratchet tool adapted to drive a work piece, comprising:
a base portion;
a head portion indexably and releasably coupled to the base portion,
wherein one of the head and base portions includes tabs and the other of the head and base portions includes corresponding grooves adapted to respectively receive the tabs, and
wherein one of the head and base portions includes detent balls biased outwardly by respective biasing members and the other of the head and base portions includes corresponding detents adapted to respectively receive the detent balls.

10. The tool of claim 9, wherein the base portion is adapted to couple to a clamshell housing having first and second clamshell housing portions.

11. The tool of claim 10, wherein a radial flange, a T-shaped protrusion and a screw boss extend inwardly from the first clamshell housing portion.

12. The tool of claim 11, wherein the base portion includes a radial flange slot, a T-shaped aperture, and a concave channel adapted receive the radial flange, the T-shaped protrusion, and the screw boss, respectively.

13. A method of indexably coupling a driver assembly of a tool, comprising:
aligning tabs disposed on one of a head portion of the driver assembly and a base portion of the driver assembly with respectively corresponding grooves formed in the other of the head portion and the base portion;
rotating the head portion relative to the base portion; and
aligning detent balls disposed on one of the head portion and the base portion with respective corresponding detents disposed on the other of the head portion and the base portion.

14. The method of claim 13, wherein the head portion is one of a number of interchangeable head portions.
